(19) United States
(12) Patent Application Publication
(10) Pub. No.: US 2011/0262180 A1
(43) Pub. Date: Oct. 27, 2011

(54) TONER CARTRIDGE AND IMAGE FORMING APPARATUS

(75) Inventor: Kengo Suzuki, Shizuoka-ken (JP)

(73) Assignees: Toshiba Tec Kabushiki Kaisha, Tokyo (JP); Kabushiki Kaisha Toshiba, Tokyo (JP)

(21) Appl. No.: 13/090,994

(22) Filed: Apr. 20, 2011

Related U.S. Application Data
(60) Provisional application No. 61/326,595, filed on Apr. 21, 2010.

(51) Int. Cl. G03G 15/08

(52) U.S. Cl. 399/106; 399/260; 399/262

(57) ABSTRACT

According to one embodiment, in a toner cartridge, an engaging member includes a first engaging section and a sealing tape is fixed to the engaging member. A shutter includes a second engaging section and moves between a shutter first position where the shutter overlaps a toner supply port in plan view and a shutter second position where the shutter does not overlap the toner supply port in plan view. A lever includes a third engaging section and a fourth engaging section. The lever is present in a lever first position where the third engaging section and the first engaging section are disengaged. According to movement of the shutter, the lever moves in a first direction from the lever first position to a lever second position where the third engaging section engages with the first engaging section. Thereafter, the lever moves in a second direction opposite to the first direction from the lever second position to move the engaging member and the sealing tape in the second direction.

### CROSS-REFERENCE TO RELATED APPLICATION

This application is based upon and claims the benefit of priority from U.S. provisional application 61/326,595, filed on Apr. 21, 2010; the entire contents of which are incorporated herein by reference.

### FIELD

Embodiments described herein relate generally to a technique for removing a sealing tape that closes a toner supply port.

### BACKGROUND

FIG. 12 is a perspective view of a toner cartridge 2A in the past.

In the past, the toner cartridge 2A (hereinafter referred to as cartridge) used in an image forming apparatus is known. A toner supply port 31A of the cartridge 2A is sealed by a sealing tape 4A to prevent a toner from scattering from the toner supply port 31A and then closed by a shutter 6A on the sealing tape 4A.

A user pulls the sealing tape 4A in a predetermined direction while keeping the shutter 6A closed. After peeling the sealing tape 4A off the cartridge 2A, the user inserts the cartridge 2A into the image forming apparatus and mounts the cartridge 2A in the image forming apparatus. When the cartridge 2A is inserted into the image forming apparatus, since the shutter 6A moves in an arrow direction in FIG. 12 and the toner supply port 31A opens, it is possible to supply the toner from the cartridge 2A to the image forming apparatus.

In the cartridge 2A in the past, the shutter 6A can open and close even before the cartridge 2A is mounted in the image forming apparatus. Therefore, it is likely that the shutter 6A opens because of manual operation, impact, or the like before the cartridge 2A is mounted in the image forming apparatus. If the sealing tape 4A is peeled while the shutter 6A is open, it is likely that the toner scatters and the user and things around the user are soiled.

If the cartridge 2A in the past is mounted in the image forming apparatus when the user fails to peel the sealing tape 4A, although the toner is carried in the cartridge 2A, the toner is not supplied from the cartridge 2A to the image forming apparatus. Therefore, it is likely that the toner is compressed and adheres to the cartridge 2A and the cartridge 2A is locked. Further, it is likely that the toner itself cannot be reused, a new toner needs to be prepared, and a breakdown of a motor for carrying the toner is caused.

### DESCRIPTION OF THE DRAWINGS

FIG. 1 is a diagram of the configuration of an image forming apparatus;

FIG. 2 is a schematic diagram of a front cover;

FIG. 3 is a perspective view of a cartridge in which a shutter is present in an initial position;

FIG. 4 is a perspective view of the cartridge with a toner container shown transparent;

FIG. 5 is a sectional view for explaining a method of attaching a sealing tape;

FIG. 6 is a plan view of an engaging member and the sealing tape;

FIG. 7 is a perspective view of a fourth engaging section;

FIGS. 8A to 8C are perspective views for explaining the operation of a shutter and a lever viewed from the front side of the shutter;

FIGS. 9A to 9C are sectional views of a state in which the cartridge is inserted into the image forming apparatus;

FIG. 10A to 10C are perspective views for explaining the operation of the shutter and the lever viewed from the rear side of the shutter;

FIGS. 11A to 11C are plan views for explaining the operation of the lever; and

FIG. 12 is a perspective view of a cartridge in the past.

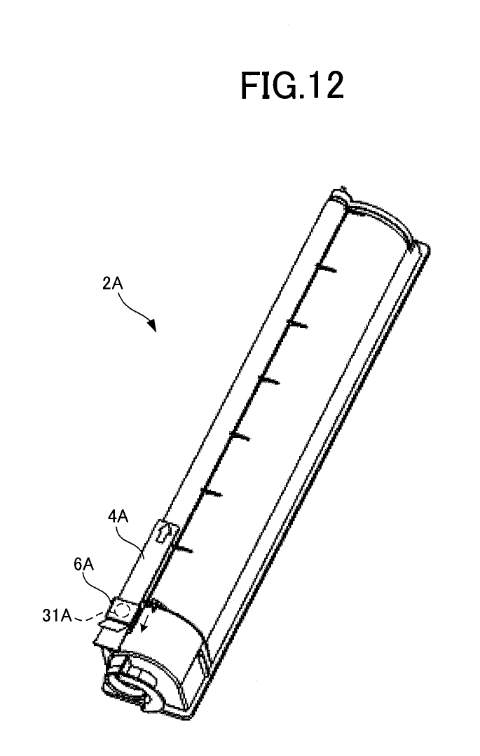

### DETAILED DESCRIPTION

In general, according to one embodiment, an image forming apparatus includes a toner cartridge and an image forming apparatus main body. The toner cartridge includes a toner container, a sealing tape, an engaging member, a shutter, and a lever. The toner container includes a toner supply port for discharging a toner to the outside and stores the toner. The sealing tape closes the toner supply port. The engaging member includes a first engaging section and the sealing tape is fixed to the engaging member. The shutter includes a second engaging section and moves between a shutter first position where the shutter overlaps the toner supply port in plan view and a shutter second position where the shutter does not overlap the toner supply port in plan view. The lever includes a third engaging section and a fourth engaging section. The lever is present in a lever first position where the third engaging section and the first engaging section are disengaged. When the shutter moves from the shutter first position to the shutter second position, the fourth engaging section and the second engaging section engage. According to the movement of the shutter, the lever moves in a first direction from the lever first position to a lever second position where the third engaging section engages with the first engaging section. Thereafter, the lever moves in a second direction opposite to the first direction from the lever second position to move the engaging member and the sealing tape in the second direction and release closing of the toner supply port by the sealing tape.

An embodiment is explained below with reference to the drawings.

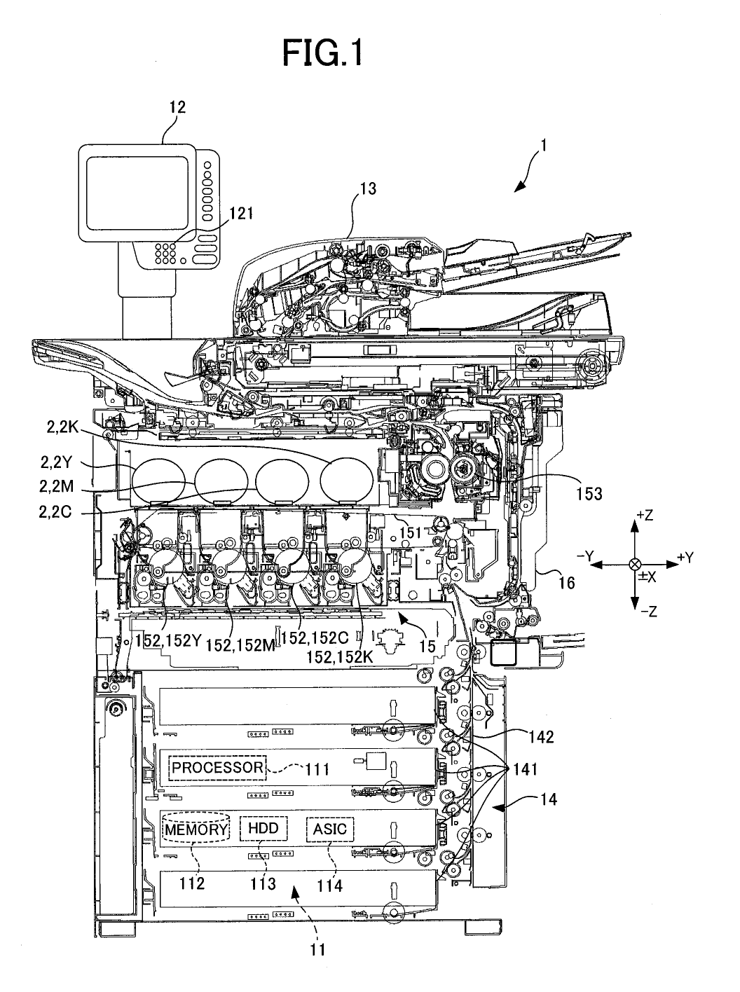

FIG. 1 is a diagram of the configuration of an image forming apparatus 1.

The image forming apparatus 1 is a MFP (Multi Function Peripheral). The image forming apparatus 1 includes a control unit 11, a display unit 12, an image reading unit 13, a sheet supply unit 14, an image forming unit 15, and a toner container 16. The control unit 11 includes a processor 111, a memory 112, a HDD (Hard Disk Drive) 113, and an ASIC (Application Specific Integrated Circuit) 114 and controls the entire image forming apparatus 1. The display unit 12 includes an operation input unit 121 configured to receive setting and displays setting and the like of the image forming apparatus 1. The image reading unit 13 is an ADF (Auto Document Feeder) and reads a document. The sheet supply unit 14 picks up sheets from paper feeding cassettes 141 one by one and conveys the sheet to the image forming unit 15 via a conveying path 142.

The image forming unit 15 includes toner cartridges 2 (2Y, 2M, 2C, and 2K), a transfer belt 151, developing devices 152 (152Y, 152M, 152C, and 152K), and a fixing device 153. The toner cartridges 2 (2Y, 2M, 2C, and 2K) store toners of respective colors and supply the toners of the colors respectively to the developing devices 152 (152Y, 152M, 152C, and 152K). The transfer belt 151 transfers toner images onto the sheet conveyed from the sheet supply unit 14. The developing devices 152 (152Y, 152M, 152C, and 152K) form toner images of the colors on the transfer belt 151, sequentially superimpose the toner images of the colors, and form one color toner image. The fixing device 153 heats and presses the sheet to fix the toner images on the sheet.

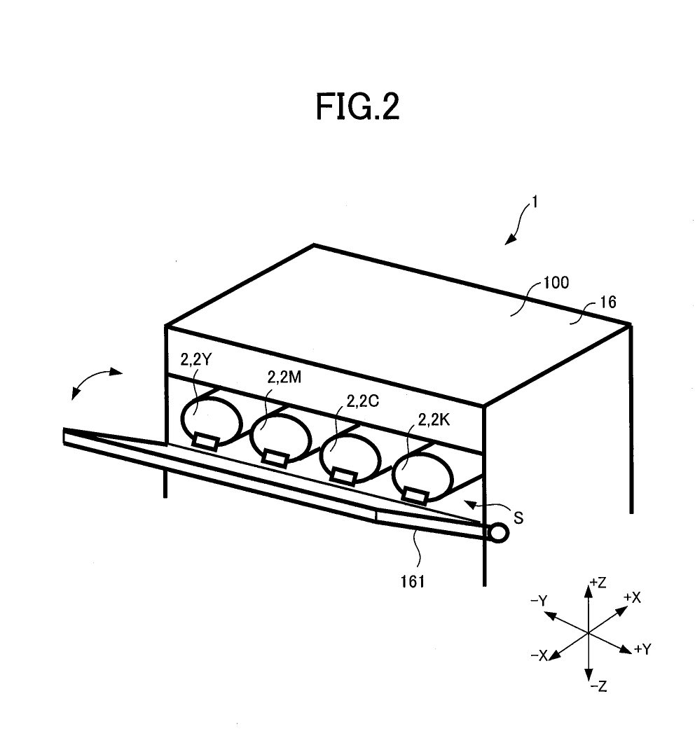

The toner container 16 houses the units 11 to 15. As shown in FIG. 2, the toner container 16 includes a front cover 161. The front cover 161 pivots in a direction for closing a cartridge housing space S, in which the toner cartridges 2 (hereinafter referred to as cartridges) are housed, and a direction for opening the cartridge housing space S. An image forming apparatus main body 100 into which the toner cartridges 2 are inserted and from which the toner cartridges 2 are pulled out includes the front cover 161.

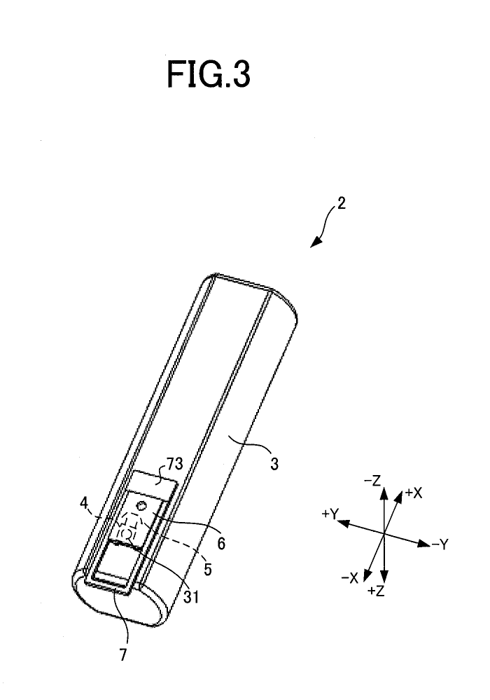

FIG. 3 is a perspective view of the cartridge 2 in which the shutter 6 is present in an initial position.

The cartridge 2 includes a toner container 3, a sealing tape 4, an engaging member 5, a shutter 6, and a lever 7.

The toner container 3 stores toner. The toner container 3 includes a toner supply port 31 for discharging the toner to the outside. In FIG. 3, the longitudinal direction of the toner container 3 is set as +−X directions. In FIG. 3, a direction that is orthogonal to the longitudinal direction of the toner container 3 and is the horizontal direction when the toner container 3 is housed in the image forming apparatus 1 is set as +−Y directions. In FIG. 3, a direction that is the vertical direction when the toner container 3 is housed in the image forming apparatus 1 is set as +−Z directions. The toner container 3 is inserted into the image forming apparatus 1 from the +X direction side in a state in which a surface on the −Z direction side in FIG. 3, on which the shutter 6 is present, faced down.

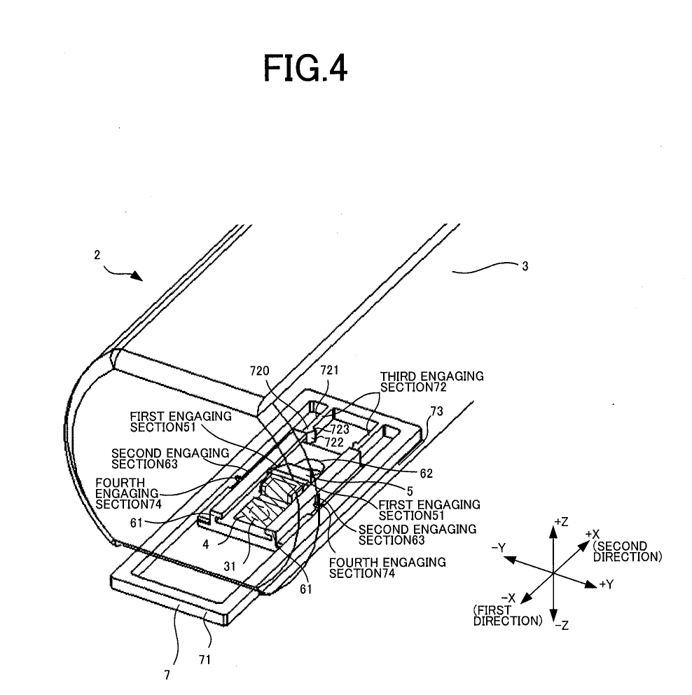

FIG. 4 is a perspective view of the cartridge 2 with the toner container 3 shown transparent.

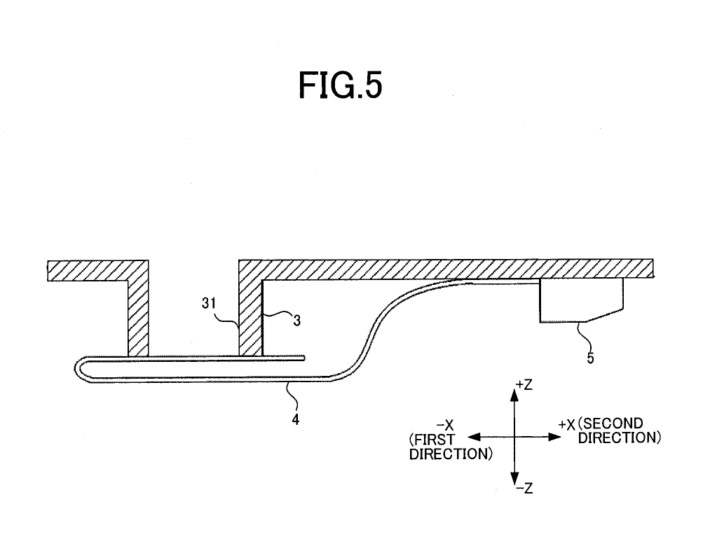

When the shutter 6 is present in the initial position, the sealing tape 4 is present between the shutter 6 and the toner container 3 and is not seen from the outside. The sealing tape 4 has a longitudinal shape. A −X direction side end of the sealing tape 4 is bonded and fixed to the periphery of the toner supply port 31 of the toner container 3. A +X direction side end of the sealing tape 4 is bonded and fixed to the engaging member 5. Specifically, as shown in FIG. 5, the −X direction side end of the sealing tape 4 is bonded and fixed to the periphery of the toner supply port 31 of the toner container 3 and closes the toner supply port 31. After the sealing tape 4 is folded back on a −X direction distal end side in the +X direction, the +X direction side end of the sealing tape 4 is bonded and fixed to the engaging member 5. Bonding force of the sealing tape 4 to the periphery of the toner supply port 31 of the toner container 3 is set rather weak such that the sealing tape 4 peels from the periphery of the toner supply port 31 of the toner container 3 when the engaging member 5 is pulled in the +X direction. The sealing tape 4 is tightly bonded to the engaging member 5 to prevent the sealing tape 4 from peeling from the engaging member 5 when the engaging member 5 is pulled in the +X direction.

When the shutter 6 is present in the initial position, the engaging member 5 is present between the shutter 6 and the toner container 3 and is not seen from the outside. The sealing tape 4 is bonded and fixed to the engaging member 5.

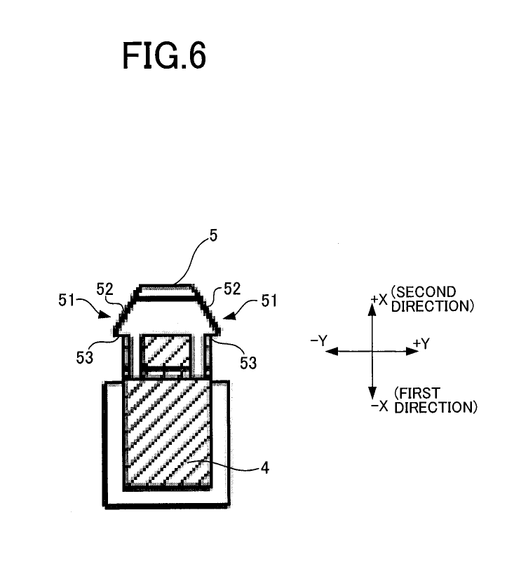

FIG. 6 is a plan view of the engaging member 5 and the sealing tape 4.

The engaging member 5 includes two first engaging sections 51. The first engaging sections 51 include first slopes 52 and first step surfaces 53. The first slopes 52 expand to the outer side of the engaging member 5 in the Y direction toward the −X direction distal end side. The first step surfaces 53 are connected to −X direction distal ends of the first slopes 52 and extend to the center side of the engaging member 5 in the Y direction.

Referring back to FIG. 4, the shutter 6 has a rectangular shape and includes second guide sections 61, a hole 62, and second engaging sections 63. The second guide sections 61 are provided at both ends in the Y direction and extend in the X direction. The second guide sections 61 have a U shape opening to the center side of the shutter 6 in sectional view in the X direction. A first guide section that is parallel to the X direction and projects in the Y direction is provided on the outer surface of the toner container 3. The second guide sections 61 are inserted into the first guide section, regulates movement of the shutter 6 in the Y direction (a third direction), and guides movement of the shutter 6 in the −X direction (a first direction) and the +X direction (a second direction). The shutter 6 moves between an initial position (a shutter first position) where the shutter 6 overlaps the toner supply port 31 in plan view and a cartridge mounting position (a shutter second position) where the toner supply port 31 and the hole 62 overlap in plan view.

The hole 62 is present on the +X direction side of the shutter 6. When the shutter 6 is present in the initial position, the hole 62 is present further on the +X direction side than the toner supply port 31. When the cartridge 2 is mounted in the image forming apparatus 1 and the shutter 6 moves in the −X direction, the hole 62 communicates with the toner supply port 31. The second engaging sections 63 project in the Y direction from side surfaces of the shutter 6.

The lever 7 is made of resin and includes a frame-like section 71 (a U-shaped section), third engaging sections 72, a protection sheet 73 (an opposed surface), and fourth engaging sections 74.

The frame-like section 71 has a rectangular frame shape. The frame-like section 71 includes the shutter 6 arranged on the inner side and regulates movement of the lever 7 in the Y direction. The frame-like section 71 guides movement of the lever 7 in the X direction.

Two third engaging sections 72 are provided. The third engaging sections 72 include arm sections 721 and pawl sections 720. The arm sections 721 extend from a +X direction side end of the frame-like section 71 to the −X direction side. The pawl sections 720 are present at −X direction ends of the arm sections 721. The pawl sections 720 include second slopes 722 and second step surfaces 723. The second slopes 722 are present at −X direction ends of the arm sections 721 and parallel to the first slopes 52 (FIG. 6). The second step surfaces 723 are connected to +X direction distal end sides of the second slopes 722 and parallel to the first step surfaces 53 (FIG. 6).

The protection sheet 73 is made of PET (Polyethylene Terephthalate) and fixed to the +X direction side on the outer surface of the frame-like section 71. The protection sheet 73 extends in the Y direction and lies between sides of the frame-like section 71 (see FIG. 3). The protection sheet 73 is opposed to the toner container 3 across the third engaging sections 72.

Two fourth engaging sections 74 are respectively present in the centers in the X direction of the sides of the frame-like section 71.

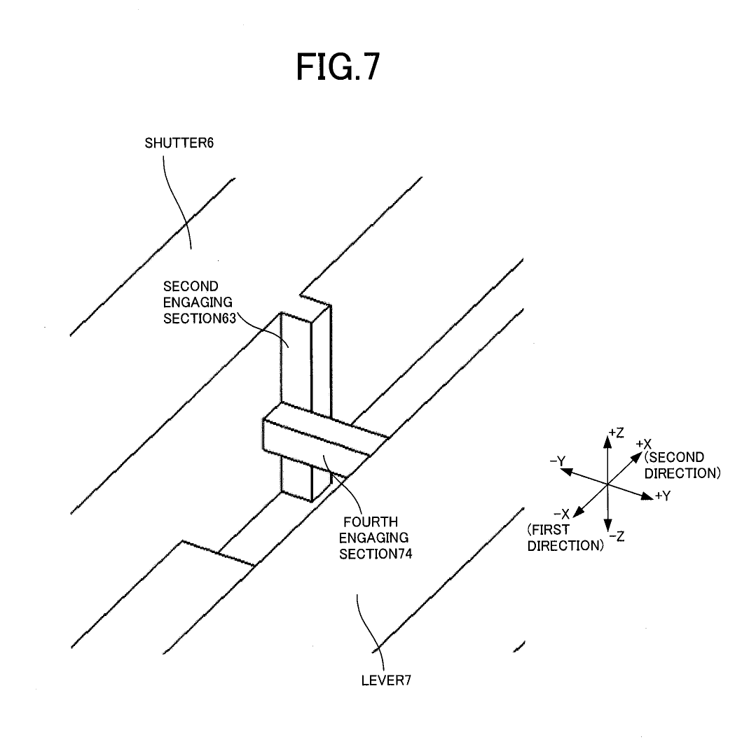

FIG. 7 is a perspective view of the fourth engaging section 74 on the +Y direction side.

The fourth engaging section 74 projects to the shutter 6 side from the inner side surface of the frame-like section 71. When the lever 7 is present in a lever first position where the third engaging section 72 and the first engaging section 51 are disengaged as shown in FIG. 6, as shown in FIG. 7, the fourth engaging section 74 is present on the −X direction side of the second engaging section 63 and comes into contact with the second engaging section 63. The strength of the fourth engaging section 74 is set to strength enough for breaking the base of the fourth engaging section 74 if the lever 7 moves in the +X direction side in a state in which the shutter 6 is fixed, i.e., a state in which the second engaging section 63 is fixed.

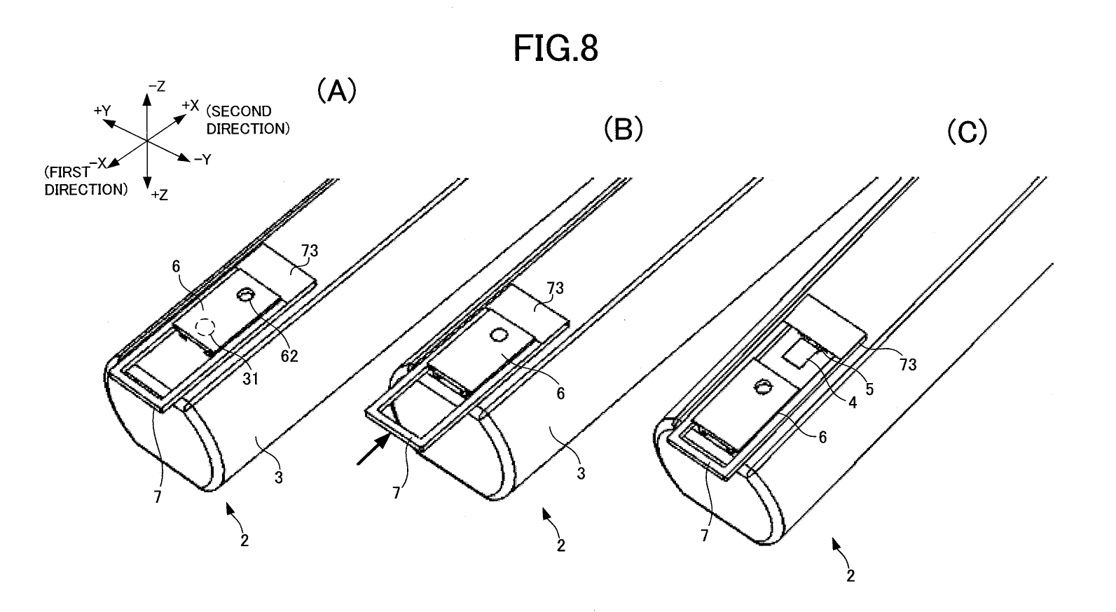

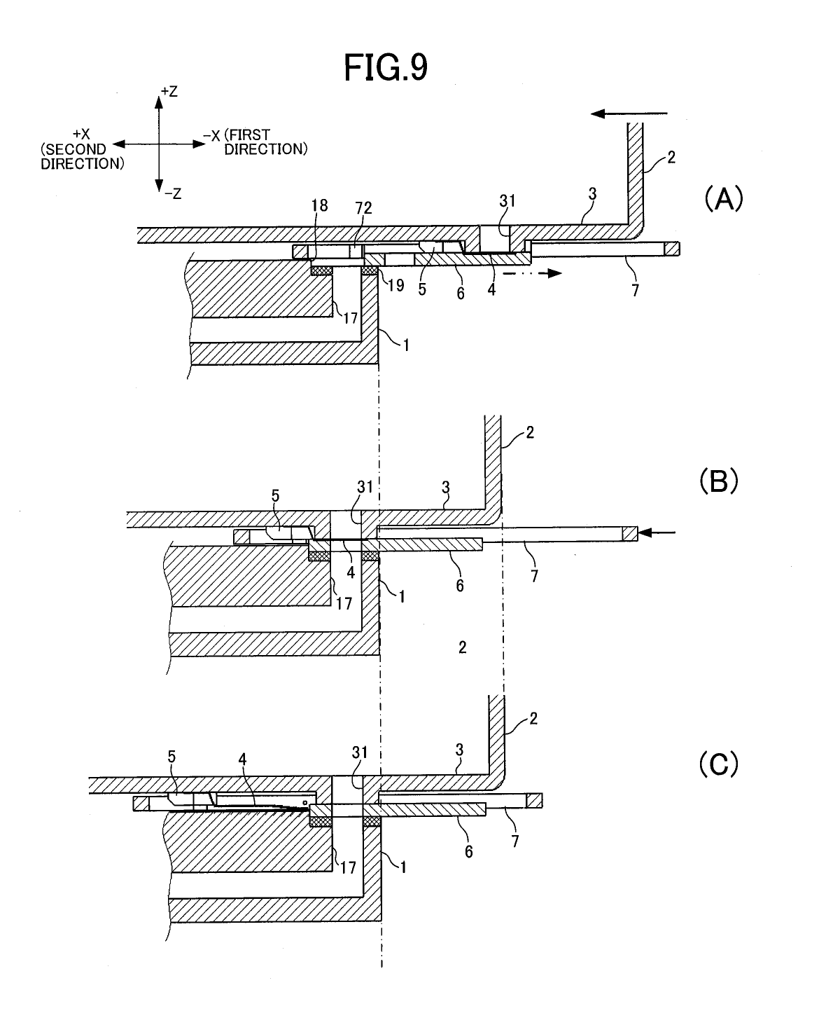

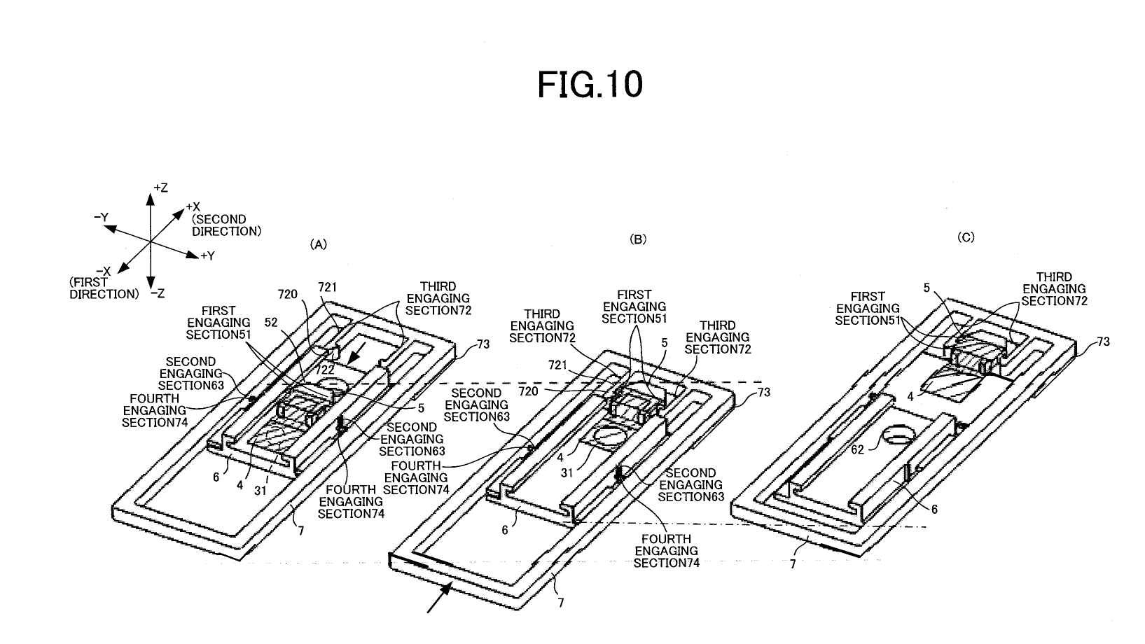

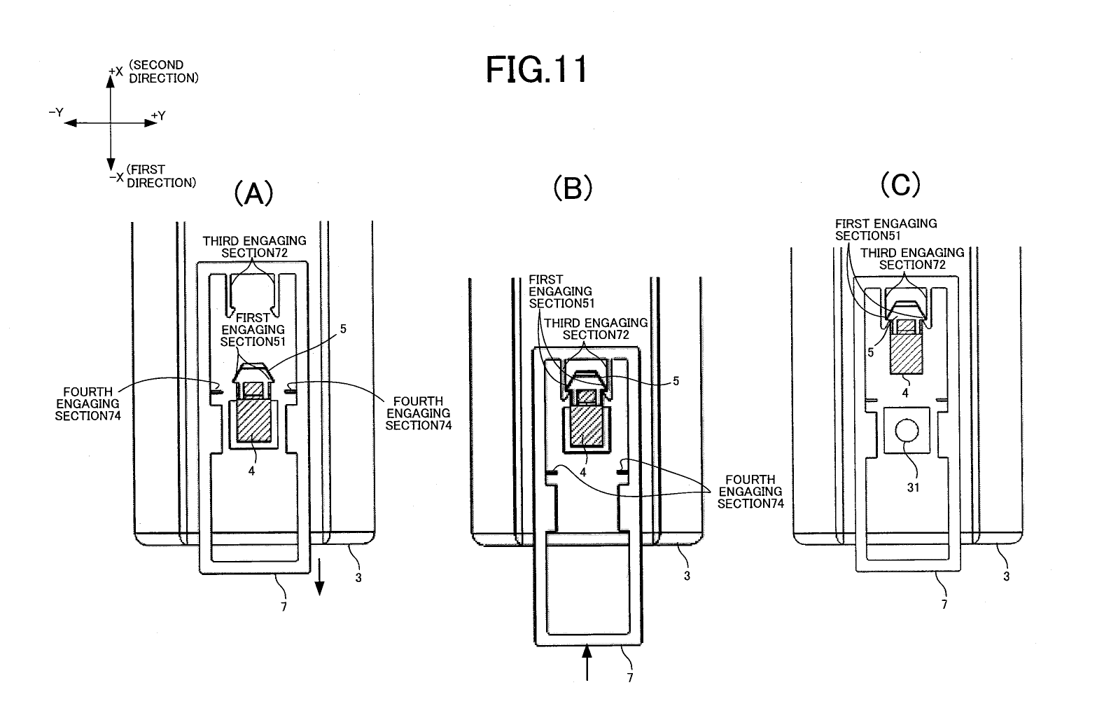

FIGS. 8A to 8C to FIGS. 11A to 11C are diagrams for explaining operation for removing the sealing tape 4 by the engaging member 5, the shutter 6, and the lever 7. FIGS. 8A to 8C are perspective views for explaining the operation of the shutter 6 and the lever 7 viewed from the front side of the shutter 6. FIGS. 9A to 9C are sectional views of a state in which the cartridge 2 is inserted into the image forming apparatus 1. FIGS. 10A to 10C are perspective views for explaining the operation of the shutter 6 and the lever 7 viewed from the rear side of the shutter 6. FIGS. 11A to 11C are plan views for explaining the operation of the lever 7. FIGS. 8A to 8C to FIGS. 11A to 11C include FIGS. 8A, 9A, 10A, and 11A that are diagrams for explaining the operation performed when the shutter 6 is present in the initial position, FIGS. 8B, 9B, 10B, and 11B for explaining the operation performed when the shutter 6 is present in the cartridge mounting position, and FIGS. 8C, 9C, 10C, and 11C for explaining the operation performed when the front cover 161 is closed.

As shown in FIG. 8A, in the cartridge 2 before being inserted into the image forming apparatus, the toner supply port 31 is closed by the sealing tape 4. The shutter 6 is present in the initial position (the shutter first position) where the shutter 6 overlaps the toner supply port 31 in plan view. In the cartridge 2 before being inserted into the image forming apparatus 1, as shown in FIG. 10A, at an initial stage (before the insertion of the cartridge 2 into the image forming apparatus 1), the lever 7 is present in the lever first position where the third engaging sections 72 and the first engaging sections 51 of the engaging member 5 are disengaged. The second engaging sections 63 of the shutter 6 are present further on the +X direction side than the fourth engaging sections 74 of the lever 7 and come into contact with the fourth engaging sections 74.

As shown in FIG. 9A, on the inside of the image forming apparatus 1, a hole 17 for connecting the toner supply port 31 and the developing devices 152 is present in a region where the cartridge 2 is inserted. A shutter stopper 18 is present near the hole 17. A gasket 19 for preventing toner leakage is present between the hole 17 and the cartridge 2.

When the cartridge 2 in which the shutter 6 is present in the initial position is inserted into the image forming apparatus 1 in the +X direction, the shutter stopper 18 comes into contact with the shutter 6, slides the shutter 6 in the −X direction relatively to the toner container 3, and locates the shutter 6 in the cartridge mounting position (the shutter second position) where the toner supply port 31 and the hole 62 overlap in plan view (FIG. 9B). In a state in which the cartridge 2 is simply inserted into the image forming apparatus 1, the sealing tape 4 is still present between the toner supply port 31 of the cartridge 2 and the hole 17 in the image forming apparatus 1.

When the shutter 6 moves in the −X direction relatively to the toner container 3, the shutter 6 pushes the fourth engaging sections 74 of the lever 7 in the −X direction with the second engaging sections 63. As shown in FIG. 10B, the shutter 6 moves the lever 7 in the −X direction from the lever first position where the third engaging sections 72 and the engaging member 5 are disengaged to the lever second position where the third engaging sections 72 engage with the engaging member 5. When the lever 7 moves in the −X direction, the second slopes 722 come into contact with the first slopes 52 of the first engaging sections 51. The arm sections 721 bend to the outer side of the lever 7 in the Y direction as the second slopes 722 climb the first slopes 52 according to the movement of the lever 7 in the −X direction. When the second slopes 722 finish climbing the first slopes 52, as shown in FIG. 10B, the pawl sections 720 move into the first engaging sections 51 and the bend of the arm sections 721 is released.

As explained above, in this embodiment, when the cartridge 2 is inserted into the image forming apparatus 1, the shutter 6 automatically moves in the −X direction and is located in the cartridge mounting position where the toner supply port 31 and the hole 62 overlap in plan view. The shutter 6 moving in the −X direction pushes the fourth engaging sections 74 of the lever 7 in the −X direction with the second engaging sections 63 to move the lever 7 in the −X direction and meshes the third engaging sections 72 of the lever 7 with the engaging member 5. According to the movement of the lever 7 in the −X direction, as shown in FIG. 8B, the −X direction side of the lever 7 projects from the toner container 3.

After the cartridge 2 is inserted into the image forming apparatus 1, when the front cover 161 is closed, the front cover 161 pushes the −X direction side of the lever 7, which projects from the toner container 3, into the +X direction side. At this point, the fourth engaging sections 74 of the lever 7 push the second engaging sections 63 of the shutter 6 in the +X direction. However, the shutter 6 is supported by the shutter stopper 18 and does not move. Therefore, when a certain degree of force is applied to the lever 7 by the front cover 161, the bases of the fourth engaging sections 74 are broken and the lever 7 moves to the +X direction side.

When the lever 7 moves to the +X direction side, as shown in FIG. 10C, the lever 7 moves the engaging member 5 in the +X direction with the third engaging sections 72 and peels the sealing tape 4 off the periphery of the toner supply port 31. Consequently, the closing of the toner supply port 31 by the sealing tape 4 is released and toner supply from the cartridge 2 to the developing devices 152 can be performed. The −X direction side end of the sealing tape 4 bonded and fixed to the periphery of the toner supply port 31 is folded back to the +X direction side (a direction in which the sealing tape 4 is pulled). In this embodiment, according to a state of bonding force to the periphery of the toner supply port 31 and the folding-back in the pulling direction, if the sealing tape 4 is pulled in the +X direction with a certain degree of force, the sealing tape 4 can be smoothly peeled off the periphery of the toner supply port 31.

As shown in FIG. 100, the lever 7 remains meshing with the engaging member 5 even after the engaging member 5 is moved in the +X direction. The engaging member 5 is housed between the protection sheet 73 and the toner container 3 by the protection sheet 73. Therefore, in this embodiment, the engaging member 5 and the sealing tape 4 fixed to the engaging member 5 can be held integral with the cartridge 2 without being dropped from the cartridge 2. Consequently, in this embodiment, the cartridge 2 can be used while the engaging member 5 and the sealing tape 4 are kept integrated with the cartridge 2.

As explained above, in this embodiment, the sealing tape 4 can be removed simply by inserting the cartridge 2 into the image forming apparatus 1 and closing the front cover 161. Therefore, the user can remove the sealing tape 4 without being conscious of special work and convenience of the image forming apparatus 1 can be improved. In this embodiment, the sealing tape 4 can be automatically removed by closing the front cover. Therefore, lock of the cartridge 2 due to a failure to peel the sealing tape 4 can be prevented. Further, in this embodiment, the sealing tape 4 can be removed in a state in which the cartridge 2 is inserted into the image forming apparatus 1. Therefore, scattering of the toner can be prevented and the user and things around the user can be prevented from being soiled.

### Modification

In the embodiment, the lever 7 is pushed in by closing the front cover 161 of the image forming apparatus 1 and the sealing tape 4 is peeled. Therefore, if the front cover 161 bends or an attaching position of the front cover 161 fluctuates, the push-in of the lever 7 is adversely affected. Therefore, after the cartridge 2 is inserted into the image forming apparatus 1, the user may directly push the lever 7 projecting from the cartridge 2 into the cartridge 2 side. In this case, a failure to remove the sealing tape 4 can be prevented by configuring the cartridge 2 and the image forming apparatus 1 such that the front cover 161 interferes with the lever 7 and cannot be closed in a state in which the lever 7 is not pushed in.

As explained in detail above, according to the technique described in this specification, it is possible to provide a technique for removing a sealing tape that closes a toner supply port.

While certain embodiments have been described, these embodiments have been presented by way of example only, and are not intended to limit the scope of invention. Indeed, the novel apparatus, methods and system described herein may be embodied in a variety of other forms; furthermore, various omissions, substitutions and changes in the form of the apparatus, methods and system described herein may be made without departing from the spirit of the inventions. The accompanying claims and their equivalents are intended to cover such forms or modifications as would fall within the scope and spirit of the inventions.

What is claimed is:

1. A toner cartridge comprising:
a toner container including a toner supply port for discharging toner to an outside and configured to store the toner;
a sealing tape that closes the toner supply port;
an engaging member including a first engaging section, at least apart of the sealing tape being fixed to the engaging member;
a shutter including a second engaging section and configured to move between a shutter first position where the shutter overlaps the toner supply port in plan view and a shutter second position where the shutter does not overlap the toner supply port in plan view; and
a lever including a third engaging section and a fourth engaging section, the lever being present in a lever first position where the third engaging section and the first engaging section are disengaged, when the shutter moves from the shutter first position to the shutter second position, the fourth engaging section and the second engaging section engaging, according to the movement of the shutter, the lever moving in a first direction from the lever first position to a lever second position where the third engaging section engages with the first engaging section, and, thereafter, moving in a second direction opposite to the first direction from the lever second position to move the engaging member and the sealing tape in the second direction and release closing of the toner supply port by the sealing tape.

2. The toner cartridge according to claim 1, wherein the sealing tape has a longitudinal shape, a one end side distal end of the sealing tape is bonded to a periphery of the toner supply port of the toner container and closes the toner supply port, the sealing tape is folded back to the second direction side on a first direction distal end side, and the other end side of the sealing tape, which is a second direction side end of the sealing tape, is fixed to the engaging member.

3. The toner cartridge according to claim 1, wherein, when the shutter is present in the shutter second position and the lever moves from the lever second position in the second direction in a state in which the second engaging section engages with the fourth engaging section, the fourth engaging section is broken if movement of the shutter in the second direction is regulated.

4. The toner cartridge according to claim 1, wherein the lever includes an opposed surface opposed to the toner container across the engaging member when the lever is present in the lever second position.

5. The toner cartridge according to claim 1, wherein
a first guide section parallel to the first direction is present on an outer surface of the toner container,
the shutter includes a second guide section configured to engage with the first guide section, regulate movement of the shutter in a third direction orthogonal to the first direction, and guide movement of the shutter in the first direction and the second direction, and
the lever includes a U-shaped section formed in a U shape in plan view, including the shutter arranged on an inner side thereof, and configured to regulate movement of the lever in the third direction and guide movement of the lever in the first direction and the second direction.

6. The toner cartridge according to claim 5, wherein the engaging member is present between the shutter and the toner container when the shutter is present in the shutter first position.

7. The toner cartridge according to claim 1, wherein
the toner container has a longitudinal shape,
the first direction is a direction from a center side to an end side of the toner container, and
the second direction is a direction from the end side to the center side of the toner container.

8. The toner cartridge according to claim 1, wherein
the fourth engaging section extends in a direction orthogonal to the first direction, and
the second engaging section extends in the direction orthogonal to the first direction and is present further on a first direction distal end side than the fourth engaging section when the shutter moves from the shutter first position to the shutter second position.

9. The toner cartridge according to claim 1, wherein
the first engaging section includes a first slope that expands to an outer side of the engaging member in a direction orthogonal to the first direction toward a first direction distal end side and a first step surface that is connected to the first direction distal end of the first slope and extends to a center side of the engaging member in the direction orthogonal to the first direction, and
the third engaging section includes an arm section that extends in the second direction, a second slope that is present at a second direction distal end of the arm section and parallel to the first slope, and a second step surface that is connected to a second direction distal end side of the second slope and parallel to the first step surface.

10. A toner cartridge comprising:
a toner container including a toner supply port for discharging toner to an outside and configured to store the toner;
a sealing tape that closes the toner supply port;
an engaging member including a first engaging section, the sealing tape being fixed to the engaging member;
a shutter configured to move between a shutter first position where the shutter overlaps the toner supply port in plan view and a shutter second position where the shutter does not overlap the toner supply port in plan view; and
a lever including a third engaging section, the lever being present in a lever first position where the third engaging section and the first engaging section are disengaged and, after moving in the first direction from the lever first position to a lever second position where the third engaging section engages with the first engaging section, in a state in which the shutter is present in the shutter second position, moving in a second direction opposite to the first direction from the lever second position to move the engaging member and the sealing tape in the second direction and release closing of the toner supply port by the sealing tape.

11. An image forming apparatus comprising:
a toner cartridge including:
a toner container including a toner supply port for discharging toner to an outside and configured to store the toner;
a sealing tape that closes the toner supply port;
an engaging member including a first engaging section, the sealing tape being fixed to the engaging member;
a shutter including a second engaging section and configured to move between a shutter first position where the shutter overlaps the toner supply port in plan view and a shutter second position where the shutter does not overlap the toner supply port in plan view; and
a lever including a third engaging section and a fourth engaging section, the lever being present in a lever first position where the third engaging section and the first engaging section are disengaged, when the shutter moves from the shutter first position to the shutter second position, the fourth engaging section and the second engaging section engaging, according to the movement of the shutter, the lever moving in a first direction from the lever first position to a lever second position where the third engaging section engages with the first engaging section, and, thereafter, moving in a second direction opposite to the first direction from the lever second position to move the engaging member and the sealing tape in the second direction and release closing of the toner supply port by the sealing tape; and
an image forming apparatus main body configured to move the lever in the second direction from the lever second position, the toner cartridge being inserted into the image forming apparatus main body.

12. The apparatus according to claim 11, wherein the sealing tape has a longitudinal shape, a one end side distal end of the sealing tape is bonded to a periphery of the toner supply port of the toner container and closes the toner supply port, the sealing tape is folded back to the second direction side on a first direction distal end side, and the other end side of the sealing tape, which is a second direction side end of the sealing tape, is fixed to the engaging member.

13. The apparatus according to claim 11, wherein the sealing tape has a longitudinal shape, a one end side distal end of the sealing tape is bonded to a periphery of the toner supply port of the toner container and closes the toner supply port and, after being folded back on a first direction distal end side, the sealing tape extends in the second direction, and the other end side of the sealing tape is fixed to the engaging member.

14. The apparatus according to claim 11, wherein, when the shutter is present in the shutter second position and the lever moves from the lever second position in the second direction in a state in which the second engaging section engages with the fourth engaging section, the fourth engaging section is broken if movement of the shutter in the second direction is regulated.

15. The apparatus according to claim 11, wherein the lever includes an opposed surface opposed to the toner container across the engaging member when the lever is present in the lever second position.

16. The apparatus according to claim 11, wherein the image forming apparatus main body comes into contact with the shutter when the toner cartridge is inserted in the first direction, moves the shutter in the second direction relatively to the toner container, and locates the shutter in the shutter second position.

17. The apparatus according to claim 11, wherein
a first guide section parallel to the first direction is present on an outer surface of the toner container,
the shutter includes a second guide section configured to engage with the first guide section, regulate movement of the shutter in a third direction orthogonal to the first direction, and guide movement of the shutter in the first direction and the second direction, and
the lever includes a U-shaped section formed in a U shape in plan view, including the shutter arranged on an inner side thereof, and configured to regulate movement of the lever in the third direction and guide movement of the lever in the first direction and the second direction.

18. The apparatus according to claim 11, wherein the engaging member is present between the shutter and the toner container when the shutter is present in the shutter first position.

19. The apparatus according to claim 11, wherein
the toner container has a longitudinal shape,
the first direction is a direction from a center side to an end side of the toner container, and
the second direction is a direction from the end side to the center side of the toner container.

20. The apparatus according to claim 11, wherein
the fourth engaging section extends in a direction orthogonal to the first direction, and
the second engaging section extends in the direction orthogonal to the first direction and is present further on a first direction distal end side than the fourth engaging section when the shutter moves from the shutter first position to the shutter second position.
